(19) United States
(12) Patent Application Publication
(10) Pub. No.: US 2015/0361622 A1
(43) Pub. Date: Dec. 17, 2015

(54) Flexible Accessible Railroad Pan System

(71) Applicant: Geoff Grantland, Townsend, DE (US)

(72) Inventor: Geoff Grantland, Townsend, DE (US)

(21) Appl. No.: 14/737,899

(22) Filed: Jun. 12, 2015

Related U.S. Application Data
(60) Provisional application No. 62/011,735, filed on Jun. 13, 2014.

(51) Int. Cl. E01B 19/00; B65D 21/02; F16L 33/00; B65D 1/34

(52) U.S. Cl. CPC E01B 19/006; B65D 1/34; B65D 21/0201; F16L 33/00

(57) ABSTRACT

A flexible Metal pan system used to collect and contain spilled liquids or granular substances that are being loaded or unloaded from railroad tank cars. Shallow rectilinear pans with drainage points at either or both ends, that rest on the railroad ties, installed between the rails, in conjunction with parallel pans installed on the outside of the rails. Multiple pans can be connected end to end as required. All connection points are secured with flexible attachments such as springs or elastomeric materials. Flexible drainage hoses connect to a transfer tank mounted between the ties. Recessed connection points are easily accessed by removing covers located at both ends of the pans. A transfer tank is equipped with an exit port that can be attached to storage tanks.

### FIELD OF INVENTION

This invention relates to secondary containment systems designed to prevent contamination of the environment. More specifically it relates to railroad pan systems that are installed between and alongside railroad tracks to collect spillage that occurs during the transfer of liquids from railroad tank cars or the fueling of locomotives.

### BACKGROUND OF INVENTION

Various spill collection systems that incorporate a center pan mounted between the rails with a pair of adjacent pans mounted outside of the rails exist. Materials used for the construction of railroad containment pan systems include cast concrete, Fiberglass, Plastic and metal. The existing collection systems use rigid connection points or sleeves that allow for vertical movement only. Connection points are often under the pans and require heavy equipment to access connections or make repairs. Rigid connection points result in material fatigue and eventual failure from lateral movement caused by factors such as expansion and contraction due to temperatures change, and shifting of liquids as railroad tankers move. The improvement of using flexible connectors at all connection points allows the system to be installed on curved sections of track and eliminates connection point material fatigue. Easily accessed connection points eliminate damage caused by removing collection pans to access connections. To insure that the environmental damage due to contamination does not occur during the transfer of hazardous liquid substances from railway tank cars, a method of spill containment is required. The embodiment of the present invention allows for the safe transfer of said substances. Poorly designed railway collection systems pans give a false sense of security. Failures of connections that are often hidden below railroad collection pans can lead to contamination of the soil and eventually the surrounding environment.

### SUMMARY OF INVENTION

The various exemplary embodiments of the present invention includes an apparatus designed for the collection of liquid substances that are spilled during the transfer of said substances during the loading or offloading of railroad tanker trains. The railroad spill containment system is comprised of a set of three shallow rectilinear pans. The first collection pan is positioned between the rails resting on the railroad ties. The two side pans are located outside and adjacent to the rails. Multiple sets of pans can be connected end to end using flexible connectors such as tension springs or elastomeric materials. At the end of a set of multiple pans a cap or plug is used to terminate the set. Substances that are accidently spilled during the transfer process flow into the pans. The substance then flows into the drains provided at the end or ends that lead to the transfer tank. Substances flow to the transfer tank that is equipped with an exit port that flows via a pipe or hose to a recovery pump or collection tank. Optional grates can be installed at the top of each pan to create a walkway. The advantage of the flexible connections used in this invention is increased longevity of the pans, increased protection to the environment and a reduced cost of maintenance and repair.

### BRIEF DESCRIPTION OF DRAWINGS

FIG. 1 is a perspective view of the invention depicting the center and outside pans that rests upon the railroad ties and is installed parallel to the railway rails. The placement of the pans is located beneath the railroad tankers.

FIG. 2 is an end view of the invention depicting the relationship of the three containment pans to the transfer tank, the railway rails and the railroad ties.

FIG. 3 is a perspective view of the transfer tank.

FIG. 4 is a detailed depiction of the connection area that joins pans lengthwise as needed to accommodate the required area of containment.

### DESCRIPTION OF EMBODIMENTS

The various exemplary embodiments of the present invention, which will become more apparent as the description proceeds, are described in the following detailed description in conjunction with the accompanying drawings, in which:

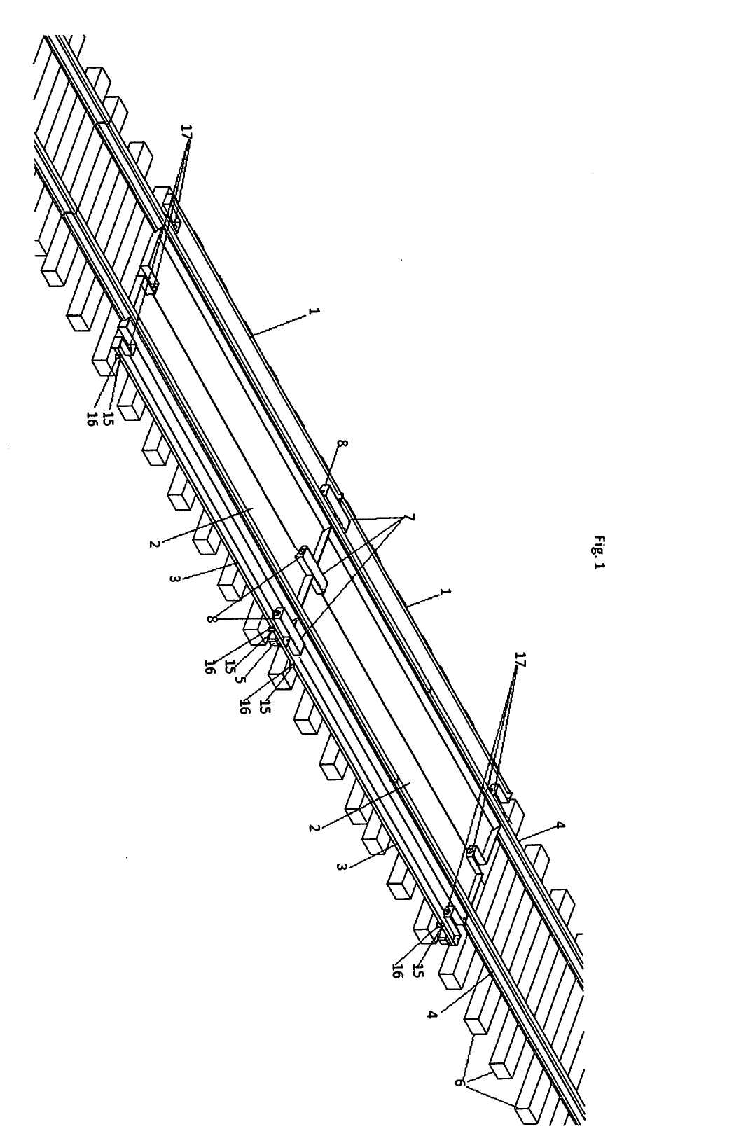

FIG. 1 is an illustrated perspective view representation of the present invention comprising a Center pan (2) that rests upon railroad ties (6) installed between railway rails (4) in conjunction with side pans (1) and (3) that rest upon railroad ties (6) installed outside of and parallel to railway rails (4) that are joined end to end as depicted to accommodate the desired area required. Pans drain through the connection area (8) to the transfer tank (5) that is mounted between and parallel to the railroad ties (6) just below the side pans and center pan (1) and (2) that can be attached to storage tanks or a recovery pump.

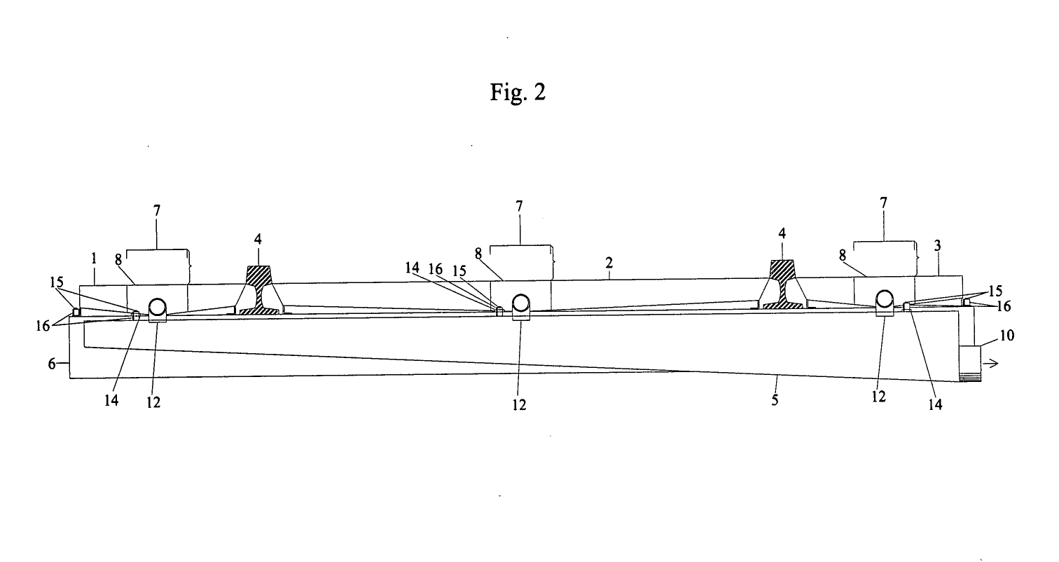

FIG. 2 is an illustrated end view representation of the present invention comprising a Center pan (2) held in place by the connection to the transfer tank, gravity and the railway rails (4) that rests upon railroad ties (6) in conjunction with side pans (1) and (3) that rest upon railroad ties (6) and are installed outside of and parallel to railway rails (4) bolted in place using bolts (15) equipped with Isolation bushings (16) to allow movement, that are joined end to end with tension springs (13) as required. Pans drain through the connection area (8) that has a cover (7) to the transfer tank (5) that is mounted in between and connected to the railroad ties (6) with a support bar (14) that is attached with a bolt (15) that has flexibility due to the Isolation bushing (16) The drain nipple (10) at the end of the transfer tank (5) is to be attached to storage tanks or a recovery pump (not depicted).

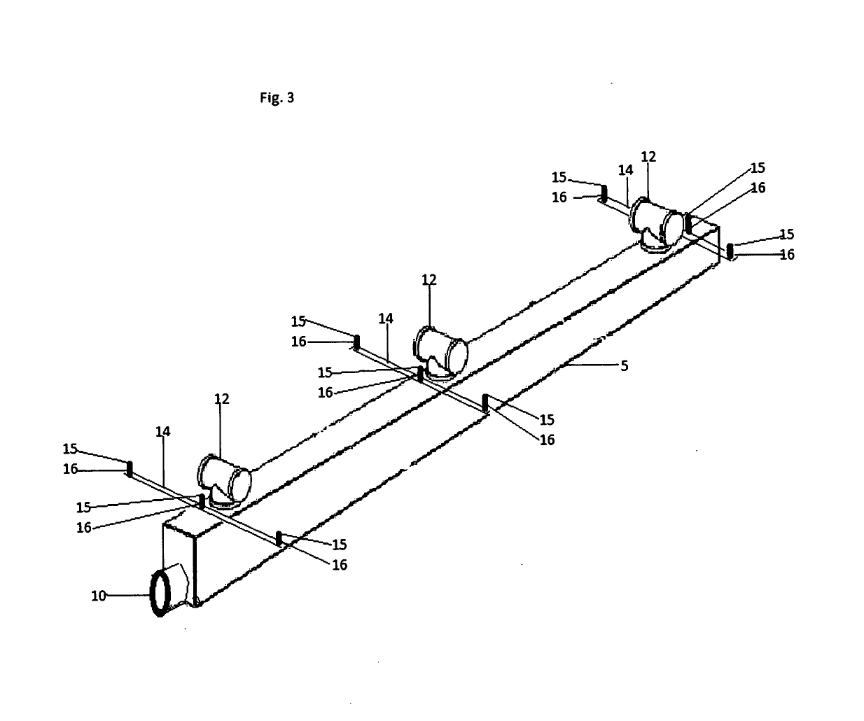

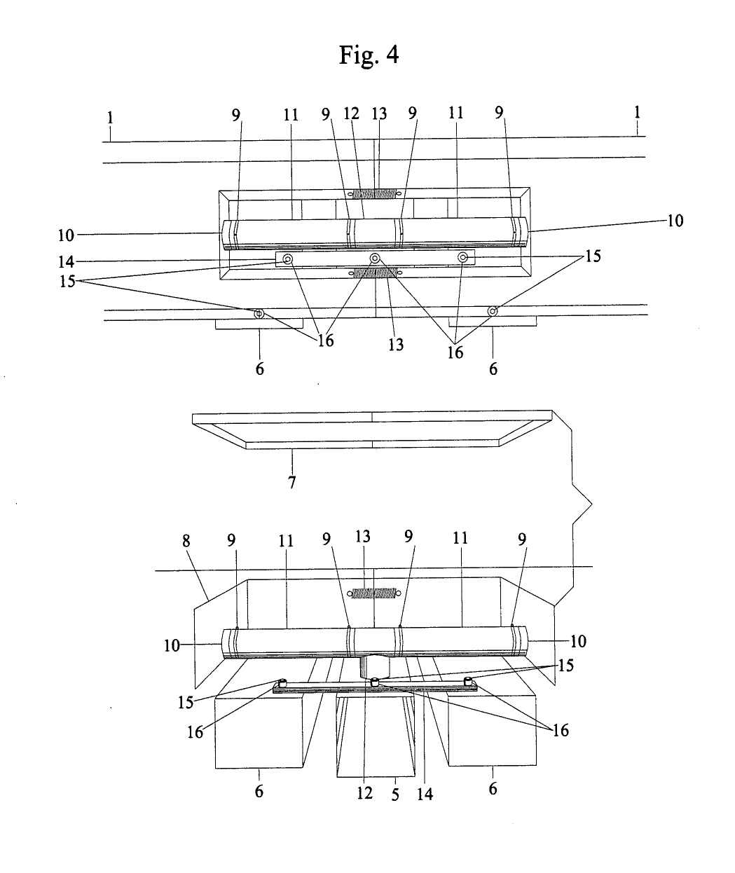

FIG. 3 is an illustrated perspective view representation of the transfer tank assembly comprising of a transfer tank (5) that is mounted between and parallel to the railroad ties (6) just below the pans (1),(2) and (3). The transfer tank is supported by support bars (14) that are bolted to the top of the transfer tank (5) and the railroad ties (6) using bolts (15) equipped with isolation bushings (16) that allow movement in all directions. The three connection tees (12) that ared installed on the top of the transfer tank accommodate the flow of liquid via the flexible hose (11) depicted in FIG. 4 from the pans (1) and (2) depicted in FIG. 2. The drain nipple (10) is to be attached to storage tanks or a recovery pump (not depicted).

FIG. 4 comprises of two illustrated perspective views of the top of the connection area (8) located at the top side of the page, and a cross sectional view of the side of the connection area (8) located at the bottom of the page. The connection area (8) is the same for the center pan (2) and side pans (1) and (3). The transfer tank (5) is positioned between and parallel to railroad ties (6) just below the pans (1), (2) and (3) centered at the point that coincides with the end to end union of the center pan (2) and the side pans (1) and (3). The transfer tank (5) is secured in place by a support bar (14) that rests upon and is bolted to the railroad ties (6) and the top of the transfer tank (5). The bolts (15) that secure the support bar are equipped with Isolation bushings (16) that allow movement in all directions. The three connection tees (12) that are installed on the top of the transfer tank accommodate the flow of liquid via the flexible hose (11) through the connection (12) through the transfer tank (5) and out of the drain nipple (10) at the end of the transfer tank (5) that is connected to a storage tank or recovery pump.

What is claimed:

1. a flexible and accessible collection apparatus used for the capture and containment of spilled hazardous liquids that occur during the loading or offloading of railroad tankers.

2. the apparatus according to claim 1, wherein the apparatus comprises of a shallow metal rectilinear center pan mounted between and parallel to the railroad rails, resting upon the railroad ties: The center pan would be contained by a bottom and vertical end walls and angled side walls that would rest against the side of the rails.

3. The apparatus according to claim 1, wherein the apparatus comprises of two shallow metal rectilinear side pans mounted outside of and parallel to the railroad rails, resting upon the railroad ties. Each side pan would be contained by a bottom and two vertical end walls, vertical walls on the outside of the set of pans and an angled side wall that would rest against the side of the rails. Secured in place using bolts equipped with Isolation bushings.

4. The apparatus according to claim 1, wherein the bottom of the metal pans are slanted toward the center of each pan to form a channel that directs the liquid towards the horizontal drain nipple with the lowest area parallel to the railroad rails.

5. The apparatus according to claim 1, wherein a rectangular accessible connection area that is recessed is located at the end of each pan.

6. The apparatus according to claim 1, wherein the connection area has a removable cover that prevents spilled liquids from entering the connection area.

7. The apparatus according to claim 1, wherein the pans are connected end to end as needed to accommodate the required length of protected area using tension springs or elastomeric belts.

8. The apparatus according to claim 1, wherein the ends of each center pan and the ends of each side pan equipped with a drain nipple that is connected to a flexible hose or is terminated with an end cap as needed to complete a group of pans.

9. The apparatus according to claim 1, wherein a flexible hose held in place by hose clamps connects the drain nipples to the connection “T” located at the top of the transfer tank.

10. The apparatus according to claim 1, wherein a transfer tank that is equipped with three connection “T” fittings and a drain nipple are installed below the pans, between the railroad ties and are bolted in place using three support bars that are bolted in place using bolts equipped with Isolation bushings.

11. The drain nipple that is located on the end of the transfer tank allows a hose to be connected to a holding tank or transfer pump.

12. The length of pans can be customized to accommodate curved railways.
